(19) United States
(12) Patent Application Publication
(10) Pub. No.: US 2019/0197917 A1
(43) Pub. Date: Jun. 27, 2019

(54) GUIDANCE INFORMATION PRESENTATION SYSTEM, GUIDANCE INFORMATION PRESENTATION METHOD, PROGRAM, AND GUIDANCE INFORMATION PRESENTATION DEVICE

(71) Applicant: Mitsubishi Hitachi Power Systems, Ltd., Kanagawa (JP)

(72) Inventors: Akihisa ENDO, Yokohama-shi (JP); Yui KANAMURA, Yokohama-shi (JP); Toru TANAKA, Yokohama-shi (JP); Takahiro YAMAUCHI, Yokohama-shi (JP); Hiroki SUGINO, Yokohama-shi (JP)

(21) Appl. No.: 16/330,490

(22) PCT Filed: Oct. 11, 2017
(86) PCT No.: PCT/JP2017/036803

§ 371 Date: Mar. 5, 2019

(30) Foreign Application Priority Data
Oct. 14, 2016 (JP) 2016-202320

(51) Int. Cl. G09B 19/00; G06Q 50/20

(52) U.S. Cl. CPC G09B 19/00; G06Q 50/2057

(57) ABSTRACT

A guidance information presentation system includes an operation data collection unit configured to collect operation data of a plant, an operation mode determination unit configured to determine an operation mode of a plant device provided in the plant on the basis of the collected operation data, and a guidance information presentation unit configured to present guidance information according to the operation mode. Further, the guidance information presentation unit is configured to present the guidance information according to an operation state of the plant device or a department to which operating staff belongs.

### TECHNICAL FIELD

The present invention relates to a guidance information presentation system, a guidance information presentation method, a program, and a guidance information presentation device.

Priority is claimed on Japanese Patent Application No. 2016-202320, filed Oct. 14, 2016, the content of which is incorporated herein by reference.

### BACKGROUND ART

Operation systems provided in a power generation plant and the like have a function of providing guidance information for supporting an operation of an operator such as a plant inspection method or a recovery method at the time of occurrence of trouble. However, the guidance information is limited to only a small part of knowledge required for operating the plant such as routine business of inspection work or the like and reactive measures when trouble occurs.

Also, with respect to skills and knowledge of a level which cannot be learned merely by presenting guidance information, for example, Patent Document 1 discloses a plant maintenance contract including guaranteeing of details of maintenance work for the maintenance work in which skill checking and qualification certification for a technician of a user side are performed and which is performed by a certified qualified person according to the completion of technical education provided by a manufacturer utilizing information communication technology. Patent Document 2 discloses an electronic system configured to provide a customer with online support for clarifying a problem to be addressed when a consulting service is provided to the customer.

### CITATION LIST

### Patent Literature

[Patent Document 1]

Japanese Unexamined Patent Application, First Publication No. 2003-050885

[Patent Document 2]

Japanese Unexamined Patent Application, First Publication No. 2002-117159

### SUMMARY OF INVENTION

### Technical Problem

Meanwhile, conventionally provided guidance information does not necessarily conform to a current situation or a need of a user. For example, in a power generation plant or the like, a role given to a plant device may change or an operation mode may change during decades which pass from the introduction of the plant device to the disposal thereof. Knowledge and skills necessary for an operation also change if the operation mode changes. However, a system that presents guidance information in accordance with a change in a plant operation mode has not been provided. Also, in Patent Document 1, there is no description of updating the maintenance skills that the user learns in accordance with the change in the operation mode. Although the electronic system described in Patent Document 2 is effective in a case in which consulting for a problem that cannot be solved by the user is performed, appropriate information is not provided in accordance with the user's current situation.

Therefore, an objective of the present invention is to provide a guidance information presentation system, a guidance information presentation method, a program, and a guidance information presentation device capable of solving the above problems.

### Solution to Problem

According to a first aspect of the present invention, there is provided a guidance information presentation system including: an operation data collection unit configured to collect operation data of a plant; an operation mode determination unit configured to determine an operation mode of a plant device provided in the plant on the basis of the collected operation data; and a guidance information presentation unit configured to present guidance information according to the operation mode.

According to a second aspect of the present invention, the guidance information presentation system may further include an operation time calculation unit configured to calculate an operation time of the plant device on the basis of the collected operation data, wherein the operation mode determination unit may be configured to determine the operation mode of the plant device on the basis of the operation time.

According to a third aspect of the present invention, the guidance information presentation system may further include a number-of-starts calculation unit configured to calculate the number of starts of the plant device on the basis of the collected operation data, wherein the operation mode determination unit may be configured to determine the operation mode of the plant device on the basis of the operation time and the number of starts.

According to a fourth aspect of the present invention, the guidance information presentation system may further include an operation state determination unit configured to determine an operation state of the plant device on the basis of the operation data, wherein the guidance information presentation unit may be configured to present guidance information according to the operation state and the operation mode.

According to a fifth aspect of the present invention, the guidance information presentation system may further include an operation organization information acquisition unit configured to acquire information about a department belonging to an operation organization of the plant, wherein the guidance information presentation unit may further be configured to present the guidance information according to the information about the department.

According to a sixth aspect of the present invention, the guidance information presentation unit may be configured to present guidance information for prompting staff to attend a lecture of an educational service according to the information about the department and the operation mode.

According to a seventh aspect of the present invention, the guidance information presentation unit may be configured to present guidance information for prompting staff to attend a lecture of an educational service required for a generation in accordance with the generation of the staff belonging to the operation organization.

According to an eighth aspect of the present invention, the guidance information presentation system may further include a lecture attendance information acquisition unit configured to acquire lecture attendance history information about an educational service of a lecture that staff belonging to the operation organization has attended, wherein the guidance information presentation unit may be configured to present guidance information for prompting the staff to receive education on the basis of the lecture attendance history information about the educational service.

According to a ninth aspect of the present invention, the guidance information presentation system may further include an organization information comparison unit configured to compare information about an operation organization of another plant with information about an operation organization of a current plant, wherein the guidance information presentation unit may be configured to present guidance information for a personnel composition of the operation organization of the current plant on the basis of the comparison.

According to a tenth aspect of the present invention, there is provided a guidance information presentation method including the steps of: collecting, by a guidance information presentation system, operation data of a plant; determining, by the guidance information presentation system, an operation mode of a plant device provided in the plant on the basis of the collected operation data; and presenting, by the guidance information presentation system, guidance information according to the operation mode.

According to an eleventh aspect of the present invention, there is provided a program for causing a computer of a guidance information presentation system to function as: a means configured to collect operation data of a plant; a means configured to identify an operation mode of a plant device provided in the plant on the basis of collected operation data; and a means configured to present guidance information according to the operation mode.

According to a twelfth aspect of the present invention, there is provided a guidance information presentation device including: a display means configured to display guidance information, wherein the display means is configured to present the guidance information according to an operation mode of a plant device.

### Advantageous Effects of Invention

According to the above-described guidance information presentation system, guidance information presentation method, and program, it is possible to provide guidance information according to current situations and needs of staff of a plant operation organization.

### BRIEF DESCRIPTION OF DRAWINGS

FIG. 1 is a schematic block diagram showing a configuration example of a guidance information presentation system in an embodiment of the present invention.

FIG. 2 is a schematic block diagram showing a configuration example of a guidance information presentation device in the embodiment of the present invention.

FIG. 3 is a flowchart showing an example of a process of the guidance information presentation device in the embodiment of the present invention.

FIG. 4 is a diagram showing a life stage determination process in the embodiment of the present invention.

FIG. 5 is a first flowchart showing an example of the life stage determination process in the embodiment of the present invention.

FIG. 6 is a second flowchart showing an example of the life stage determination process in the embodiment of the present invention.

FIG. 7 is a diagram showing an example of a relationship between a generational change of staff in a plant and a life stage of the plant.

FIG. 8 is a flowchart showing an example of a process of outputting guidance information for prompting the staff to attend a lecture of an educational service in the embodiment of the present invention.

FIG. 9 is a flowchart showing an example of a process of outputting guidance information for prompting the staff to receive education in the embodiment of the present invention.

FIG. 10 is a flowchart showing an example of a process of outputting guidance information related to a plant operation organization in the embodiment of the present invention.

FIG. 11 is a schematic block diagram showing a configuration of a computer according to the embodiment of the present invention.

### DESCRIPTION OF EMBODIMENTS

### Embodiments

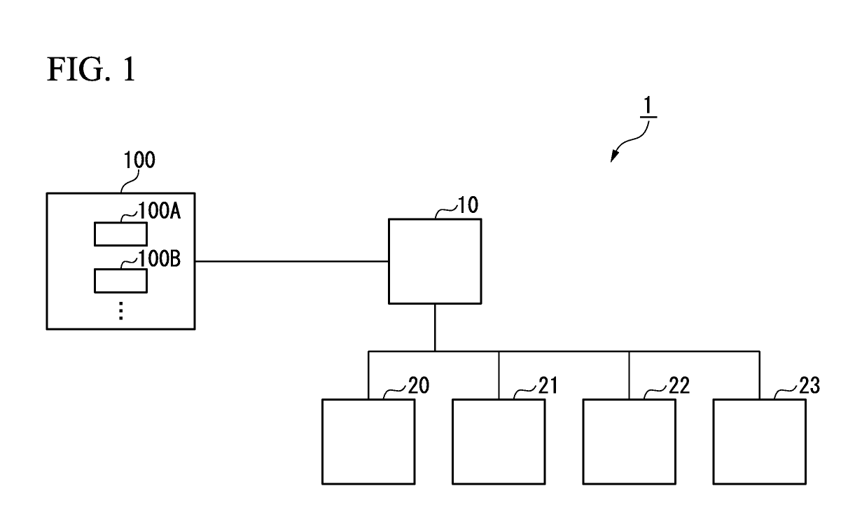

Hereinafter, a guidance information presentation system according to an embodiment of the present invention will be described with reference to FIGS. 1 to 11.

FIG. 1 is a schematic block diagram showing a configuration example of a guidance information presentation system in the embodiment of the present invention. The guidance information presentation system 1 is a system for providing various guidance information to staff of an operation organization that manages a plant according to a state of the plant to be operated, a department to which the staff of the operation organization belongs, or the like. The guidance information is, for example, technical information such as predictive detection of occurrence of trouble and a method of coping with the trouble that occurs, management information such as a daily profit and a cost reduction method, information about maintenance such as a wearing condition of components and a maintenance plan therefor, and the like. In addition to the above guidance information, the guidance information presentation system 1 of the present embodiment also presents guidance information related to persons such as guidance about educational services suitable for each staff member and advice about reconsideration of a personnel composition of the operation organization. The guidance information presentation system 1 of the present embodiment supports the operation of the plant functioning as a social infrastructure for several decades by providing guidance information for supporting the operation of the plant from various aspects throughout the plant's life cycle.

The guidance information presentation system 1 is configured to include a plant 100, a guidance information presentation device 10, a maintenance department terminal device 20, an operation department terminal device 21, a technical department terminal device 22, and a management department terminal device 23. The guidance information presentation device 10 is connected to each of a plant device 100A, a plant device 100B, the maintenance department terminal device 20, the operation department terminal device 21, the technical department terminal device 22, and the management department terminal device 23 so that the guidance information presentation device 10 can communicate therewith. A plant to be operated other than the plant 100 may be present.

The plant 100 is, for example, a power generation plant with a gas turbine combined cycle. Plant devices 100A, 100B, and the like are installed in the plant 100. The plant devices 100A and 100B are, for example, gas turbines. The plant 100 transmits operation data such as output values and rotational speeds of the plant devices 100A and 100B to the guidance information presentation device 10.

The guidance information presentation device 10 outputs guidance information to the department terminal devices 20 to 23. The plant device installed in the power generation plant has a life cycle and its role and usage change while the plant device is used for many years. Staff of a management organization needs to apply appropriate maintenance and improvement according to the change. The guidance information presentation device 10 generates the guidance information according to an operation situation of the plant device 100A, a role of each department related to the operation of the plant 100, and the like on the basis of the operation data acquired from the plant device 100A.

The maintenance department terminal device 20 is an information processing device such as a personal computer (PC) provided in the maintenance department. The staff of the maintenance department performs periodic inspection or maintenance work on the plant device.

The operation department terminal device 21 is an information processing device such as a PC provided in the operation department. The staff in the operation department conducts business related to a plant operation such as monitoring of a plant state, starting/stopping of a plant device, and a change in a target output value.

The technical department terminal device 22 is an information processing device such as a PC provided in the technical department. The staff of the technical department has expert knowledge and skills, makes various determinations from technical points of view, and solves problems that cannot be solved by the operation department or the maintenance department.

The management department terminal device 23 is an information processing device such as a PC provided in the management department. Staff in the management department will consider economic efficiency and profitability, personnel planning and power generation planning, cost reduction planning, and the like.

When the guidance information presentation device 10 generates the guidance information used by the staff of the maintenance department, the guidance information presentation device 10 transmits the guidance information to the maintenance department terminal device 20. The same applies to other departments.

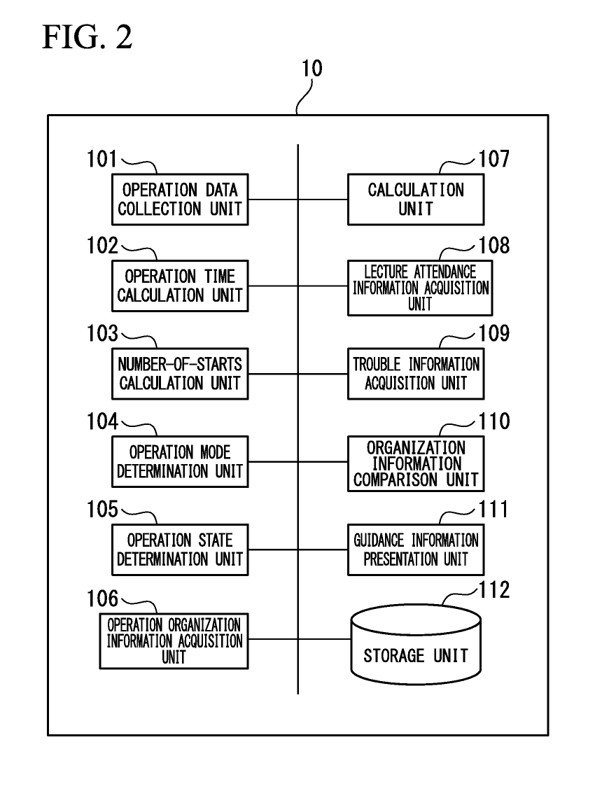

FIG. 2 is a schematic block diagram showing a configuration example of the guidance information presentation device in the embodiment of the present invention.

As shown in FIG. 2, the guidance information presentation device 10 includes an operation data collection unit 101, an operation time calculation unit 102, a number-of-starts calculation unit 103, an operation mode determination unit 104, an operation state determination unit 105, an operation organization information acquisition unit 106, a calculation unit 107, a lecture attendance information acquisition unit 108, a trouble information acquisition unit 109, an organization information comparison unit 110, a guidance information presentation unit 111, and a storage unit 112. The guidance information presentation device 10 includes computers such as one or more server terminal devices.

The operation data collection unit 101 acquires operation data transmitted by the plant 100 and records the operation data in the storage unit 112.

The operation time calculation unit 102 calculates an operation time of the plant device 100A on the basis of the operation data.

The number-of-starts calculation unit 103 calculates the number of starts of the plant device 100A on the basis of the operation data.

The operation mode determination unit 104 identifies a life stage of the plant device 100A or the like (a gas turbine or the like) provided in the plant 100 on the basis of the operation data. In the life stage, for example, “Base Load”, “Intermediate”, and “Peaker” are present in accordance with a maturity level. “Base Load” refers to a period during which the plant device operates as a central power generation device that covers power demand from the start of an operation of the plant device. In the life stage of “Base Load”, the plant device 100A is in operation all the time. Hereinafter, the life stage “Base Load” is referred to as a golden stage. “Intermediate” refers to a period of a transition stage for a new model in which the plant device passing through the golden stage is operated weekly or daily. Hereinafter, the life stage “Intermediate” is referred to as the transition stage. “Peaker” refers to a period until disposal is reached after switching to a new model. During this period, the plant device 100A is solely operated in a case in which power is insufficient or the like. Hereinafter, the life stage “Peaker” is referred to as a decline stage. The operation mode determination unit 104 determines the life stage of the plant device 100A on the basis of an operation time of the plant or an operation time and the number of starts of the plant device 100A.

The operation state determination unit 105 determines the operation state of the plant device 100A on the basis of the operation data. The determination of the operation state is a determination of whether or not the plant device 100A is in operation or whether the plant device 100A is in a state before start, a state in operation, or a state after an operation.

The operation organization information acquisition unit 106 acquires information about the department or staff of a destination to which the guidance information is presented. The information about the staff includes, for example, information such as a name, the number of years of experience in the department, and qualifications held.

The calculation unit 107 performs various calculation, analysis, and analysis processes related to the provision of the guidance information. For example, the calculation unit 107 performs simulation of profit planning for the management department. Alternatively, the calculation unit 107 creates a predictive detection model by machine learning for the operation department. Alternatively, the calculation unit 107 performs risk analysis on the plant state for the maintenance department. In addition, although various calculations, analyses, and the like are required for generating the guidance information and the calculation unit 107 is implemented as a program module for each process, the calculation unit 107 has all functions thereof in the present embodiment.

The lecture attendance information acquisition unit 108 acquires lecture attendance history information about the educational service related to the operation of the plant 100 for which staff of each of the maintenance department, the operation department, the technical department, and the management department has attended a lecture.

The trouble information acquisition unit 109 acquires trouble information generated in the plant 100.

The organization information comparison unit 110 acquires information about an operation organization of another plant and compares the acquired information with information about an operation organization of a current plant. The current plant is a plant (the plant 100 in the present embodiment) that is a target from which the guidance information presentation device 10 acquires operation data.

The guidance information presentation unit 111 generates guidance information according to the life stage, the operation state, and member information of the plant 100 and outputs the generated guidance information to a terminal device (the maintenance department terminal device 20 or the like) of each department.

The storage unit 112 stores various information.

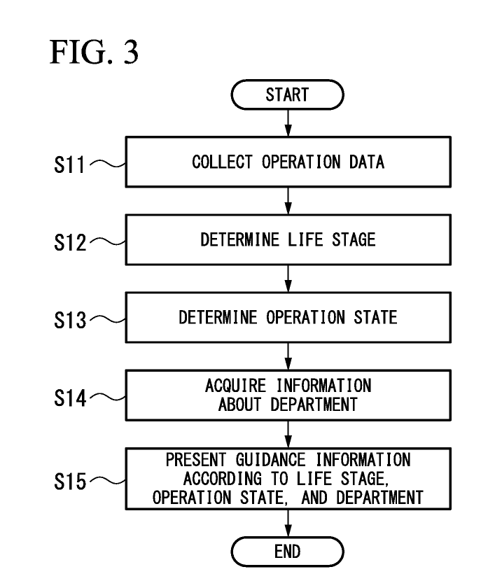

FIG. 3 is a flowchart showing an example of a process of the guidance information presentation device in the embodiment of the present invention.

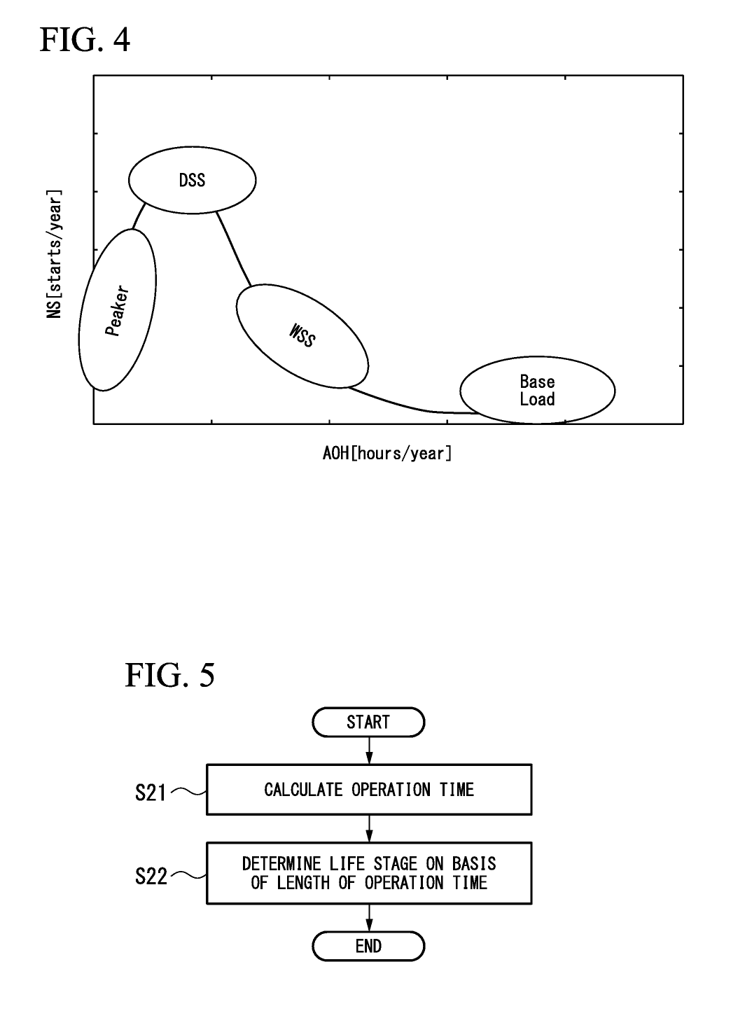

A process of presenting the guidance information related to the plant device 100A will be described with reference to FIG. 3. First, the operation data collection unit 101 collects operation data of the plant device 100A from the plant 100 and records the collected operation data in the storage unit 112 (step S11). Next, the operation mode determination unit 104 determines a life stage of the plant device 100A (step S12). Specifically, the operation mode determination unit 104 determines whether the plant device 100A is in a golden stage, a transition stage, or a decline stage. Details of a life stage determination method will be described below with reference to FIGS. 4 and 5. The operation mode determination unit 104 outputs information about the determined life stage to the guidance information presentation unit 111. Next, the operation state determination unit 105 determines a current operation state of the plant device 100A (step S13). For example, the operation state determination unit 105 reads operation data such as a latest output value and a rotational speed of the plant device 100A recorded in the storage unit 112 and determines that the plant device 100A is in operation if these values are greater than or equal to a predetermined value (for example, 0). If a value such as the read output value is less than or equal to the predetermined value, the operation state determination unit 105 determines that the operation of the plant device 100A is stopped. Further, when it is determined that the operation is stopped, for example, the operation state determination unit 105 refers to operation plan information pre-recorded in the storage unit 112, determines that the plant device 100A is in a state after an operation if a current clock time is within a predetermined time from the stopping of the operation, and determines that the plant device 100A is in a state before the operation if the current clock time is within the predetermined time retroactively from a scheduled start time defined in the operation plan information. The operation state determination unit 105 outputs information about the determined operation state to the guidance information presentation unit 111.

Next, the operation organization information acquisition unit 106 acquires information about the department for which the guidance information is presented (step S14). For example, title information indicating types and details of information to be output to the department terminal devices 20 to 23 according to each life stage and each operation state of the plant device 100A is pre-recorded in the storage unit 112, and the operation organization information acquisition unit 106 reads and acquires information about a department to which guidance information is output and types and details of guidance information to be output to the department on the basis of the information. The operation organization information acquisition unit 106 outputs information in which a presentation destination (department) and the guidance information to be presented are associated with each other to the guidance information presentation unit 111. Next, the guidance information presentation unit 111 presents guidance information corresponding to a life stage, an operation state, and a presentation destination department of the plant device 100A (step S15). An example of the guidance information is described below.

### <When Operation State is State Before Operation>

### 1. Example of Guidance Information for Maintenance Department

For example, in the storage unit 112, information indicating “additional tightening of bolts of a part XX” is pre-recorded as guidance information to be presented to the plant device 100A in all the life stages. On the basis of this record, the guidance information presentation unit 111 outputs guidance information such as “Please tighten up bolts of a part XX again” to the maintenance department terminal device 20.

For example, ideal setting values for performing an efficient operation for setting items according to, for example, each life stage and each operation environment (an outside air temperature or the like) are recorded in the storage unit 112. The guidance information presentation unit 111 reads the setting values according to the life stage determined in step S12 and the operation data (the outside air temperature or the like) collected from the plant 100 and outputs guidance information for prompting the staff to set ideal setting values in the setting items to the maintenance department terminal device 20.

For example, when a presentation destination department and a type of guidance information to be presented acquired from the operation organization information acquisition unit 106 are a “maintenance department” and “advanced risk analysis”, the guidance information presentation unit 111 instructs the calculation unit 107 to perform the advanced risk analysis. Then, for example, a program having the function of the advanced risk analysis included in the calculation unit 107 performs risk analysis according to the life stage using a well-known risk analysis technique using operation data during a previous operation stored in the storage unit 112, information about an inspection result of inspection work performed by the maintenance department after the operation, or the like. The guidance information presentation unit 111 outputs a result of risk analysis by the calculation unit 107 to the maintenance department terminal device 20. Likewise, on the basis of an instruction of the guidance information presentation unit 111, the calculation unit 107 may predict a lifespan of a part of the plant device 100A and analyze a part to be replaced and the guidance information presentation unit 111 may output prediction and analysis results to the maintenance department terminal device 20. Staff of the maintenance department can view the guidance information and perform maintenance work before the operation.

### 2. Example of Guidance Information for Operation Department

For example, when a presentation destination department and a type of guidance information to be presented acquired from the operation organization information acquisition unit 106 are an “operation department” and an “optimum start sequence”, the guidance information presentation unit 111 instructs the calculation unit 107 to automatically create the optimum start sequence. Then, a program having a function of automatically creating the optimum start sequence included in the calculation unit 107 creates a start sequence with highest efficiency in, for example, a load band according to the life stage (for example, a rated load in the golden stage, a load lower than that during the other periods, or the like). The guidance information presentation unit 111 outputs optimum start sequence information to the operation department terminal device 21. The staff of the operation department can view the guidance information and start the plant device 100A in the optimum sequence.

The guidance information presentation unit 111 may output the guidance information to be output to the maintenance department terminal device 20 and the operation department terminal device 21 also to the technical department terminal device 22. The staff of the technical department can check the guidance information and check whether or not the guidance information is appropriate from a technical point of view.

### 3. Example of Guidance Information for Management Department

On the basis of an instruction of the guidance information presentation unit 111, the calculation unit 107 performs simulation such as a cost reduction measure (for example, a procurement method of suppressing a fuel cost or the like), staff planning of the operation department (a staff arrangement capable of performing an operation with as few people as possible in accordance with a power generation plan), or profit planning (for example, prediction of a bid price of power, calculation of a profit, and the like) in a calculation method according to the life stage. The guidance information presentation unit 111 outputs a simulation result to the management department terminal device 23. Staff of the management department can view the guidance information and perform cost reduction, an appropriate staff arrangement, profit prediction, and the like.

### <When Operation State is State in Operation>

### 1. Example of Guidance Information for Maintenance Department

The calculation unit 107 determines important inspection items to be inspected at the next regular inspection on the basis of operation data collected by the operation data collection unit 101 according to an instruction of the guidance information presentation unit 111. At this time, the calculation unit 107 may set different items in accordance with the life stage as inspection items. For example, the calculation unit 107 determines that there is an inspection item in relation to an item in which a value close to an abnormal value is output from among operation data items. The guidance information presentation unit 111 outputs information about the important inspection items to the maintenance department terminal device 20.

### 2. Example of Guidance Information for Operation Department

The calculation unit 107 performs predictive detection of trouble according to an instruction from the guidance information presentation unit 111. Specifically, in a predictive detection function provided in the calculation unit 107, a probability of occurrence of trouble indicated by latest operation data collected by the operation data collection unit 101 is calculated on the basis of a predictive detection model generated by machine learning and it is determined that there is a possibility of occurrence of trouble when a probability of occurrence is greater than or equal to a threshold value. At this time, the calculation unit 107 may switch the predictive detection model in accordance with the life stage. The guidance information presentation unit 111 outputs guidance information such as a high possibility of occurrence of trouble, details of the trouble, a prevention method and the like to the operation department terminal device 21. When trouble actually occurs, the guidance information presentation unit 111 outputs guidance information, such as a method of coping with the trouble that has occurred, to the operation department terminal device 21.

A cause of trouble and a method of coping with the trouble for each life stage are recorded in the storage unit 112 and the guidance information presentation unit 111 may output the method of coping with the trouble for each life stage at the time of occurrence of trouble. For example, when the stopping of the plant device 100A is detected, there is a possibility that an excessive thermal load due to frequent repetition of starting/stopping may be one cause if the life stage is the transition stage. In this case, the guidance information presentation unit 111 outputs information (a cause) and a countermeasure method for a portion of a high possibility of destruction or failure due to a thermal load to the operation department terminal device 21. Alternatively, if the life stage is the decline stage, there is a possibility of stopping because it is not possible to perform a normal operation due to rust according to stopping for a long period. In this case, the guidance information presentation unit 111 outputs information (a cause) or a countermeasure method for a portion where rusting is likely to occur to the operation department terminal device 21.

The cause of the trouble and the guidance information about the method of coping with the trouble may also be output to the maintenance department terminal device 20 and the technical department terminal device 22. The staff of the maintenance department and the technical department can cooperate and cope with the trouble.

<When Operation State is State after Operation>

### 1. Example of Guidance Information for Maintenance Department

For example, the calculation unit 107 performs damage evaluation on parts of the plant device 100A based on the operation data collected by the operation data collection unit 101 according to an instruction from the guidance information presentation unit 111. The guidance information presentation unit 111 outputs guidance information indicating what part is consumed to what extent, necessity of exchange/maintenance work, and the like to the maintenance department terminal device 20.

For example, information about an upgraded product that exerts an effect for each life stage is recorded in the storage unit 112. For example, if the life stage is the transition stage, the number of starts/stops increases as compared to the golden stage. An operation at a load less than the rated load may be required during the transition stage. In the storage unit 112, information about upgraded products for shortening a start time and information about upgraded products capable of being operated efficiently even with a small load are recorded in association with the life stage “transition stage”. In the storage unit 112, information about upgraded products contributing to stable operation (for improving reliability) is recorded in association with the life stage “golden stage”. The guidance information presentation unit 111 outputs information about upgraded products according to the life stage determined in step S12 or guidance information including a merit in the case of upgrading to the maintenance department terminal device 20. Staff of the maintenance department will consider application planning of upgraded products with reference to the guidance information.

### 2. Example of Guidance Information for Operation Department

For example, a result (an actual value) of the optimum start sequence created before the operation is recorded in the storage unit 112. The guidance information presentation unit 111 outputs the actual value to the operation department terminal device 21 as guidance information for prompting the staff to perform a process retrospective on a current operation.

In the exemplary example of a maintenance department, the guidance information presentation unit 111 outputs information about upgraded products and the like according to the life stage as guidance information to the operation department terminal device 21. The staff of the operation department will consider the introduction of upgraded products with reference to the guidance information.

### 3. Examples of Guidance Information for Technical Department

For example, information about upgraded products according to the life stage and information indicating technical requirements for introducing the upgraded products are recorded in the storage unit 112. The guidance information presentation unit 111 outputs information about upgraded products according to the life stage determined in step S12 and guidance information including technical requirements necessary for the introduction to the technical department terminal device 22. The staff of the technical department views the guidance information and considers whether or not the introduction into a plant of a current company is possible.

### 4. Example of Guidance Information for Management Department

For the above-described upgraded products, the guidance information presentation unit 111 reads information indicating an upgraded product, an introduction cost, and an economic benefit after introduction (information indicating that a cost can be reduced by X yen at the time of unplanned stopping because a more stable operation can be performed and the like) according to the life stage determined in step S12 from the storage unit 112 and outputs the read information as guidance information to the management department terminal device 23. The staff of the management department views the guidance information and considers the introduction of upgraded products into the plant of the current company.

The calculation unit 107 analyzes bid competitiveness and electric power demand from information about a power sales record in the current operation and the guidance information presentation unit 111 outputs analysis results as guidance information to the management department terminal device 23. Also, in this case, the calculation unit 107 may switch an analysis method in accordance with the life stage. The staff of the management department views the guidance information and considers the next power generation plan.

According to the guidance information presentation system of the present embodiment, it is possible to provide the guidance information as described above suitable for the life stage and the operation state of the plant device 100A by combining real-time operation data of the plant 100 and departments of the operation organization. Because the guidance information about details suitable for business is presented for each department, it is possible to provide guidance information according to needs of the staff of each department. By creating information about know-how and the like relying on experience so far to perform an operation and automatically presenting the created information, for example, the staff of the operation department with less experience can safely operate the plant. By presenting guidance information suitable for a situation of the plant, it is possible to efficiently operate the plant.

Next, the life stage determination method in step S12 of the flowchart of FIG. 3 will be described.

FIG. 4 is a diagram showing a life stage determination process in an embodiment of the present invention.

In FIG. 4, a vertical axis represents the number of starts (the number of times/year), and a horizontal axis represents an operation time (an operation time/year). A graph of FIG. 4 shows a relationship of the life stage, the number of starts, and the operation time of the plant device 100A. For example, the operation time is shortened in the decline stage (“Peaker” in the drawing) and the number of starts is small and the operation time is long in the golden stage (“Base Load” in the drawing). In the transition stage (“DSS” and “WSS” in the drawing), the operation time is longer than that in the decline stage and the number of starts is larger than that in the decline stage. DSS is an operation mode in which starting/stopping is performed on a daily basis, and WSS is an operation mode in which starting/stopping is performed on a weekly basis (stop on the weekends). Using the above-described properties of each life stage, the operation mode determination unit 104 determines the life stage of the plant device 100A.

FIG. 5 is a first flowchart showing an example of a life stage determination process in the embodiment of the present invention.

A first method of the life stage determination process will be described with reference to FIG. 5.

First, the operation time calculation unit 102 calculates a total of operation times during a corresponding period from information such as a starting time and a stopping time included in operation data of the plant device 100A during a predetermined period (for example, 1 year, 1 month, 6 months, or the like) recorded in the storage unit 112 (step S21). The operation time calculation unit 102 outputs the total operation time to the operation mode determination unit 104. Next, the operation mode determination unit 104 determines the life stage on the basis of the length of the operation time (step S22). For example, the length of the operation time (a threshold value A) for distinguishing the transition stage and the decline stage with respect to the length of the above-described predetermined period and the length of the operation time (a threshold value B) for distinguishing the transition stage and the golden stage are predetermined (threshold value B>threshold value A), and the operation mode determination unit 104 determines the life stage by comparing the total of the operation times calculated by the operation time calculation unit 102 with the threshold values (the threshold value A and the threshold value B). Specifically, when the total of the operation times is less than or equal to the threshold value A, the operation mode determination unit 104 determines that the life stage of the plant device 100A is the decline stage. When the total of the operation times is greater than the threshold value A and less than the threshold value B, the operation mode determination unit 104 determines that the life stage of the plant device 100A is the transition stage. When the total of the operation times is greater than or equal to the threshold value B, the operation mode determination unit 104 determines that the life stage of the plant device 100A is the golden stage.

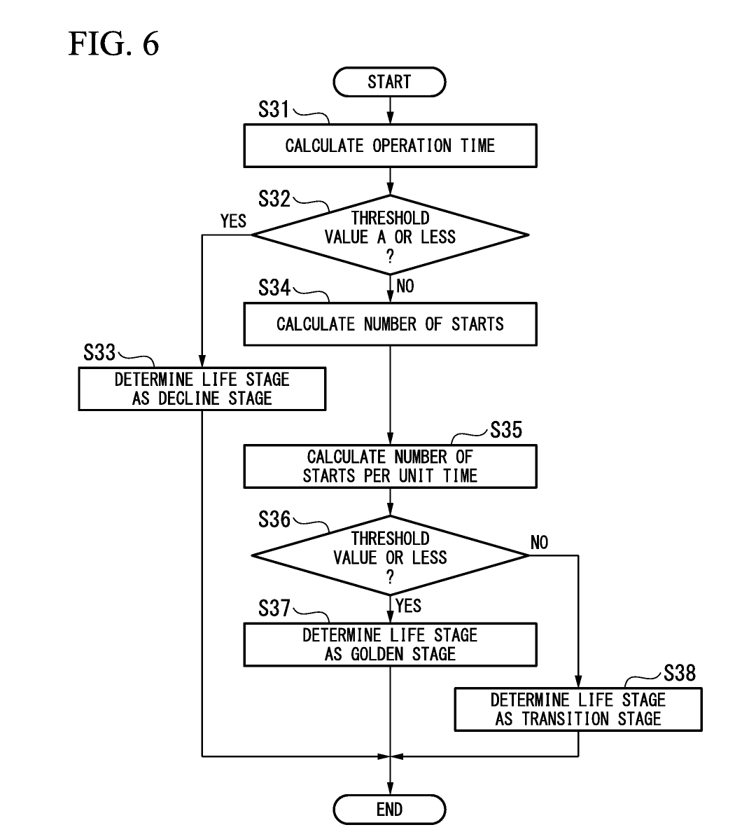

Next, another method of the life stage determination process will be described with reference to FIG. 6.

FIG. 6 is a second flowchart showing an example of a life stage determination process in the embodiment of the present invention.

First, the operation time calculation unit 102 calculates a total of operation times of the plant device 100A during a predetermined period as in step S21 (step S31). The operation time calculation unit 102 outputs the total operation time to the operation mode determination unit 104. Next, the operation mode determination unit 104 separates the decline stage from the other life stages on the basis of the length of the operation time. Specifically, the operation mode determination unit 104 determines whether or not the length of the operation time is less than or equal to the threshold value A (step S32). Here, the threshold value A is the length of the operation time for distinguishing the decline stage and the transition stage as described with reference to FIG. 5. When the total of the operation times is less than or equal to the threshold value A (step S32; Yes), the operation mode determination unit 104 determines that the life stage of the plant device 100A is the decline stage (step S33).

When the total of the operation times is greater than the threshold value A (step S32; No), the number-of-starts calculation unit 103 calculates the number of starts of the plant device 100A during a predetermined period (step S34). For example, the number-of-starts calculation unit 103 calculates the number of starts during the period by aggregating information such as a start clock time included in the operation data of the plant device 100A during the predetermined period recorded in the storage unit 112. The number-of-starts calculation unit 103 outputs the calculated number of starts to the operation mode determination unit 104. Next, the operation mode determination unit 104 calculates the number of starts per unit period (step S35). Specifically, the operation mode determination unit 104 obtains the number of starts per unit period by dividing the number of starts calculated in step S34 by the operation time calculated in step S31. Next, the operation mode determination unit 104 compares the calculated number of starts per unit period with the threshold value C (step S36). As shown in FIG. 4, the life stage can be determined to be the transition stage when the number of starts per unit period is large and can be determined to be the golden stage when the number of starts per unit period is small. The threshold value C is a threshold value of the number of starts per unit period for distinguishing the transition stage and the golden stage.

When the number of starts per unit period is less than or equal to the threshold value C (step S36; Yes), the operation mode determination unit 104 determines that the life stage of the plant device 100A is the golden stage (step S37). When the number of starts per unit period is greater than the threshold value C (step S36; No), the operation mode determination unit 104 determines that the life stage of the plant device 100A is the transition stage (step S38).

The operation mode determination unit 104 determines the life stage of the plant device 100A by the method described with reference to FIGS. 4 to 6. According to the present embodiment, it is possible to determine the life stage of the plant device 100A or the like on the basis of operation data collected by the operation data collection unit 101. Thereby, the guidance information presentation unit 111 can output guidance information according to the life stage to the department terminal devices 20 to 23. The staff of each department can carry out business with reference to knowledge suitable for the life stage.

A case in which the guidance information presentation system 1 of the present embodiment presents guidance information according to a situation of the plant 100 or a department has been described above. However, there is a possibility that it is not possible to sufficiently prevent unplanned stopping or the like from occurring due to a mistake of an operation monitoring person with low proficiency by merely presenting the guidance information. Although human resource development is important to avoid trouble caused by proficiency levels of members, active engagement in human resource education is not carried out in many cases in the conventional plant operation organization. To solve such a problem, the guidance information presentation system 1 of the present embodiment presents guidance information for prompting the staff to attend a lecture of an educational service. More specifically, the guidance information presentation system 1 presents an appropriate educational service in conjunction with a role and an operation method of the plant device 100A that changes in accordance with the life stage.

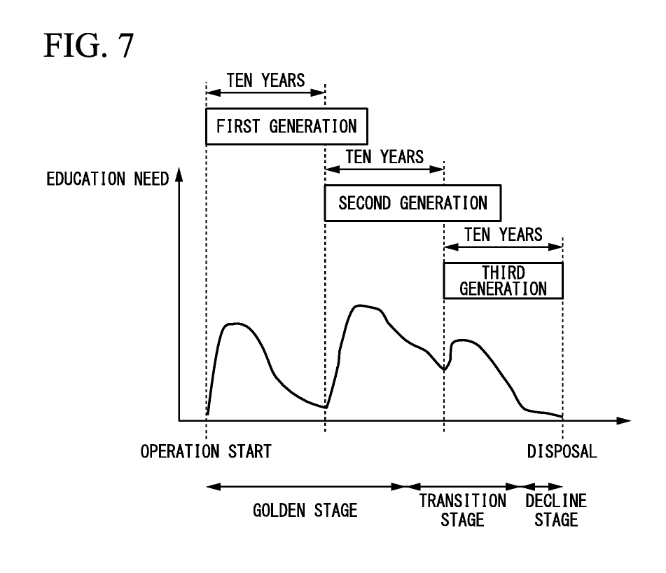

FIG. 7 is a diagram showing an example of a relationship between a generational change of staff in the plant and the life stage of the plant.

In FIG. 7, a horizontal axis represents a flow of time from an operation start to the disposal of the plant 100, and a vertical axis represents a need level of necessity for an on-site educational service at that time. In FIG. 7, first to third generations show examples of generational changes according to replacement of a group of staff who work in the business of the operation department and the maintenance department during the same period at a typical cycle. First, the staff of the first generation is a staff involved in the operation from the start of an operation of the plant. Educational needs are high for some time from the start of the operation of the plant because there is no accumulation of knowledge in the operation organization and there is much that the staff does not know. For the majority of the period during which the first generation is involved, the life stage of the plant device 100A is the golden stage. In the golden stage, the plant device 100A is in operation all the time and a stable operation is required with little change in the operation state. In the case of the golden stage, when certain knowledge is accumulated for some time from the start of the operation of the plant, educational needs will decline because the stable operation becomes possible. When ten years have elapsed from the start of the operation, the second generation is newly added. Education needs will rise for the second generation who have just arrived because there is no knowledge of the plant 100. After some time from the acquisition of knowledge on an operation in the golden stage by the second generation staff, the life stage of the plant device 100A transitions to the transition stage. When the life stage transitions to the transition stage, it is necessary to master new knowledge or skills because the number of starts/stops of the plant device 100A increases, a flexible operation is required when an operation load also takes various values, and the operation mode changes. Accordingly, even after the rise in the initial educational needs in the second generation stops, the educational needs will continue to be maintained at a certain level. When ten years have elapsed since the second generation joined, the third generation is newly added. In the third generation, educational needs will rise because there is no knowledge of the plant 100. However, when the third generation arrives, the life stage of the plant device 100A transitions to the transition stage and the role of the plant device 100A is relatively lowered. Also, there is accumulation of know-how and the like accumulated in the operation of the past twenty years. Therefore, the educational needs when the third generation is added will not be higher than those at the beginning of the two generations in the past. After some time, the life stage of the plant device 100A transitions to the decline stage. Education needs will also decline when the life stage transitions to the decline stage.

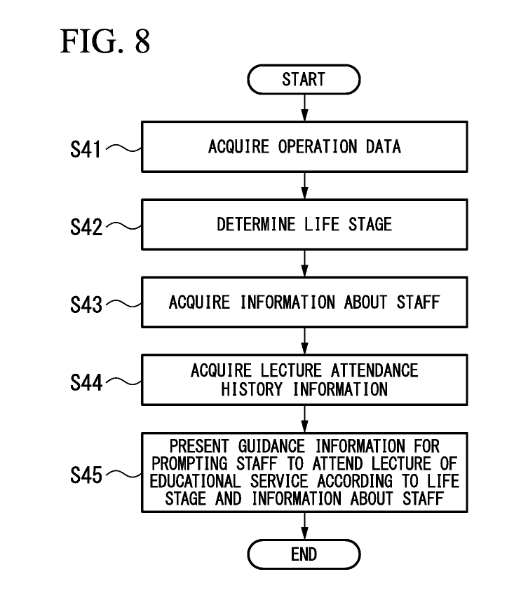

In this manner, the educational needs change dramatically due to an influence of the plant's life stage and the replacement of staff. As will be described below with reference to FIG. 8, the guidance information presentation system 1 presents guidance information for prompting the staff to attend a lecture of an appropriate educational service at a timing when education is considered to be required according to the life stage of the plant, the number of years of experience of the staff, or the like.

Meanwhile, even if the staff of the first to third generations exemplified above are engaged in the same plant device 100A, a grounded ability required according to a business environment at that time is different. For example, considering the business environment during a period for some time from the start of the operation of the plant, basic knowledge and a grounded ability such as an ability to solve problems are required for the first generation because the experience of the entire operation organization is inadequate and knowledge is insufficient during the period. In the second generation after a series of know-how is accumulated and a technically stable operation becomes possible, creativity is required in addition to the grounded ability required for the first generation to strengthen the profit structure. In the business environment during a period in which the third generation is engaged, it is necessary to refrain from capital investment as much as possible and competently increase a profit while controlling risks. On the other hand, knowledge related to an operation of the plant is sufficiently accumulated. In such an environment, in the third generation, a grounded ability such as creativity and applied skills utilizing accumulated knowledge is required. The guidance information presentation system 1 presents guidance information for guiding the educational service which extends the required grounded ability for the staff of each generation.

FIG. 8 is a flowchart showing an example of a process of outputting guidance information for prompting the staff to attend a lecture of an educational service in an embodiment of the present invention.

First, the operation data collection unit 101 collects operation data of the plant device 100A and records the collected operation data in the storage unit 112 (step S41). Next, the operation mode determination unit 104 determines a life stage of the plant device 100A (step S42). A specific determination method is as described in the flowcharts of FIGS. 5 and 6. The operation mode determination unit 104 outputs information about the determined life stage to the guidance information presentation unit 111. Next, the operation organization information acquisition unit 106 acquires information about staff to whom the guidance information is required to be presented (step S43). For example, in the storage unit 112, information such as the number of years of experience of the staff and qualifications held are recorded in association with account information about the staff. In the storage unit 112, lecture attendance history information indicating a type of educational service of lecture attendance of the staff in association with the account information about the staff is recorded. On the other hand, for example, when the maintenance staff of the maintenance department uses the maintenance department terminal device 20, his/her account information is input, and the account information is transmitted to the guidance information presentation device 10. Using the transmitted account information, the operation organization information acquisition unit 106 reads and acquires information about the staff (the number of years of experience of the staff or the like) from the storage unit 112. The operation organization information acquisition unit 106 outputs the acquired information about the staff to the guidance information presentation unit 111. The lecture attendance information acquisition unit 108 reads and acquires the lecture attendance history information of the storage unit 112 using the transmitted account information (step S44). The lecture attendance information acquisition unit 108 outputs the acquired attendance history information to the guidance information presentation unit 111.

The guidance information presentation unit 111 outputs guidance information for prompting the staff to attend a lecture of the educational service according to a life stage, the information about the staff, and the lecture attendance history information (step S45). An example of the guidance information is described below.

For example, if the number of years of experience of the staff included in the information about the staff is 0 and there is no lecture attendance history of an educational service, the guidance information presentation unit 111 presents guidance information for prompting the staff to attend a lecture of a basic educational service common to all the life stages and common to departments and a departmental-specific basic educational service. The basic education service common to the departments is, for example, a lecture that provide basic knowledge of gas turbines and peripheral devices, a lecture that provides knowledge on safety and risk management, or the like.

For example, the guidance information presentation unit 111 presents guidance information for prompting the staff to attend a lecture of the following educational service on the basis of the life stage determined in step S42, the department to which the staff belongs acquired in step S43, and the information about the lecture attendance history acquired in step S44.

<When Operation is being Performed in Golden Stage>

An educational service for “basic knowledge of a plant operation”, a “method of performing an operation without unplanned stopping”, a “method of solving common trouble”, and the like is presented for the staff of the operation department, an educational service for a “daily inspection method”, a “periodic inspection method”, and the like is presented for the staff of the maintenance department, an educational service for a “technical viewpoint of a periodic inspection”, “design philosophy”, and the like is presented for the staff of the technical department, guidance information for prompting the staff to attend a lecture of an educational service for a “periodic inspection management viewpoint”, a “capital investment/recovery optimization operation”, a “cost caused by trouble”, and the like for the management department is presented to staff who have not attended a lecture thereof.

<When Operation is being Performed in Transition Stage>

An educational service for “safe execution of frequent starting/stopping”, a “method of shortening a starting/stopping time”, and the like is presented to the staff of the operation department, an educational service for a “maintenance method for a high-temperature part that deteriorates due to continuation of heating/cooling”, a “method of applying an upgraded part”, and the like is presented to the staff of the maintenance department, and guidance information for prompting the staff to attend a lecture of an educational service for an “efficient operation with a new model” and the like for the management department is presented to staff who have not attended a lecture thereof.

<When Operation is being Performed in Decline Stage>

An “operation method of maintaining an asset value (extending a lifespan)” is presented to the staff of the operation department, a “maintenance method at the time of non-operation” is presented to the staff of the maintenance department, and guidance information for prompting the staff to attend a lecture of an educational service for a “method of making an operation plan in consideration of an external environment” and the like for the management department is presented to staff who have not attended a lecture thereof.

When an upgraded product is applied and a new device or function is added, the guidance information presentation unit 111 presents guidance information for prompting the staff to attend a lecture of an educational service that provides knowledge about the newly added function or device.

The guidance information presentation unit 111 may present guidance information for prompting the staff to attend a lecture of an educational service related to trouble, for example, when the same device as the plant device 100A is used in another plant and trouble occurs in the device.

For example, the guidance information presentation unit 111 may present a number of basic education services for the first generation and present a basic educational service of more practical details accumulated in the past operation for the second generation and the third generation, in accordance with the generation of the staff. In addition, an educational service of details suitable for nurturing the grounded ability required for each generation such as introducing of case examples of a method of improving operation efficiency established during a daily operation may be presented.

Next, an example in which guidance information about human resource education for the entire organization instead of individual staff is presented will be described.

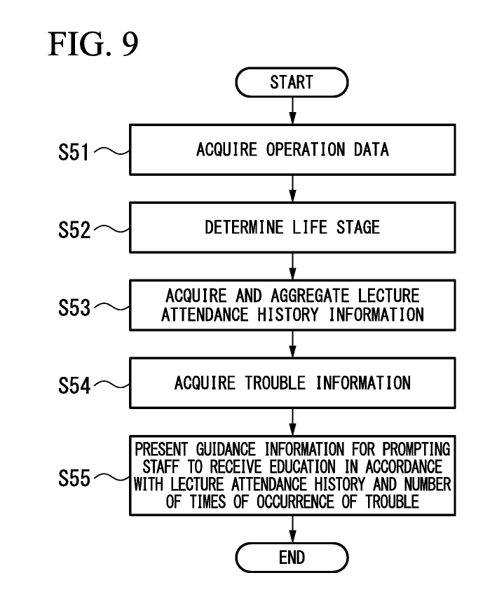

FIG. 9 is a flowchart showing an example of a process of outputting guidance information for prompting the staff to receive education in the embodiment of the present invention.

First, the operation data collection unit 101 collects operation data of the plant device 100A and records the collected operation data in the storage unit 112 (step S51). Next, the operation mode determination unit 104 determines a life stage of the plant device 100A (step S52). The specific determination method is as described in the flowcharts of FIGS. 5 and 6. The operation mode determination unit 104 outputs information about the determined life stage to the guidance information presentation unit 111.

Next, the lecture attendance information acquisition unit 108 acquires and aggregates lecture attendance history information about all staff of all departments (step S53). For example, in the storage unit 112, information such as lecture attendance histories of educational services is recorded for all the staff in all the departments. The lecture attendance information acquisition unit 108 reads the lecture attendance information and aggregates the read information according to each department. Thereby, how many staff members are attending the lecture in what educational service in what department or the total number of staff members attending the lecture according to each department and according to each educational service is aggregated. The lecture attendance information acquisition unit 108 outputs the aggregated information to the guidance information presentation unit 111.

Next, the trouble information acquisition unit 109 acquires aggregated information about trouble occurred in the plant 100 (step S54). For example, in the storage unit 112, various types of trouble occurring during a predetermined period or events leading to trouble are recorded, and the trouble information acquisition unit 109 reads the information and aggregates the information according to each trouble or event. The trouble information acquisition unit 109 outputs the aggregated information to the guidance information presentation unit 111.

Next, the guidance information presentation unit 111 presents guidance information for prompting the staff to receive education in accordance with a lecture attendance history and the number of times of occurrence of trouble (step S55). Specifically, the guidance information presentation unit 111 generates guidance information for prompting the staff to attend the lecture of an educational service for which a lecture attendance rate for a certain department is low when there is a low lecture attendance rate for the certain department in lecture attendance history information aggregated according to each department and each educational service acquired from the lecture attendance information acquisition unit 108 and outputs the generated guidance information to the management department terminal device 23. For example, in the operation department, a lecture attendance rate of a “lecture for an operation monitoring department” is assumed to be 10%. The guidance information presentation unit 111 compares the lecture attendance rate with a lower limit (for example, 60%) of the lecture attendance rate of the educational service within a department, determines that the lecture attendance rate in the operation department is low, and outputs guidance information indicating that the “lecture attendance rate of the lecture for the operation monitoring department of the operation department is 10%. Please attend the lecture for the operation monitoring department” or the like to the management department terminal device 23. The management department views the guidance information, determines that there is a possibility that a proficiency level of the operation department's skill is low, and prompts the staff to attend the lecture of the educational service for the operation department.

If the number of times of occurrence of certain trouble is greater than or equal to a predetermined threshold value in trouble-specific aggregated information acquired from the trouble information acquisition unit 109, the guidance information presentation unit 111 generates guidance information for prompting the staff to attend a lecture of an educational service for providing knowledge required to prevent the trouble and outputs the generated guidance information to the management department terminal device 23. The management department views the guidance information, determines that it is necessary to prevent trouble from reoccurring, and prompts the staff for each related department to attend a lecture of an educational service related to the trouble.

A process of outputting the guidance information for prompting the staff to receive the education may be executed periodically, for example, once a month, or may be executed at any timing according to an instruction of the staff of the management department. Thereby, it is possible to improve a level of knowledge of the entire organization, secure a certain level or more, steadily operate the plant, and strengthen a profit structure by entrusting the lecture attendance of the educational service to the department without entrusting the lecture attendance of the educational service to the individual.

Next, an example in which guidance information for outputting a consulting result related to the operation organization is presented will be described.

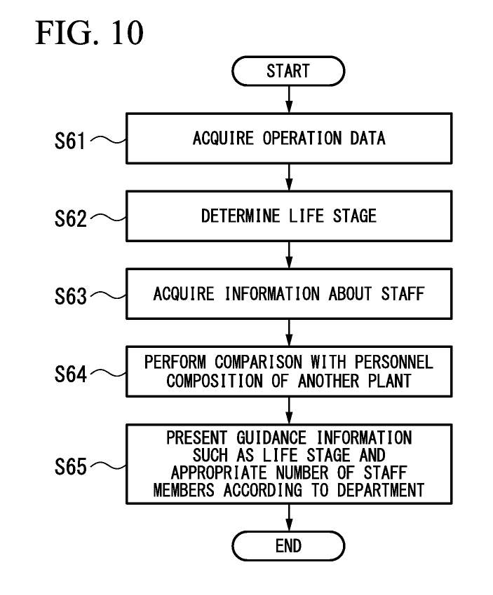

FIG. 10 is a flowchart showing an example of a process of outputting guidance information for a plant operation organization in the embodiment of the present invention.

First, the operation data collection unit 101 collects operation data of the plant device 100A and records the collected operation data in the storage unit 112 (step S61). Next, the operation mode determination unit 104 determines a life stage of the plant device 100A (step S62). A specific determination method is as described in the flowcharts of FIGS. 5 and 6. The operation mode determination unit 104 outputs information about the determined life stage to the guidance information presentation unit 111.

Next, the operation organization information acquisition unit 106 acquires information about all staff for each department (step S63). Next, the organization information comparison unit 110 compares a personnel composition of the operation organization of the plant 100 with a personnel composition of another plant (step S64). For example, information about the personnel composition (the number of staff members for each department) for each life stage in another plant having the same type of plant device is recorded in the storage unit 112. The organization information comparison unit 110 calculates the number of staff members for each department by totaling the number of staff members acquired by the operation organization information acquisition unit 106. The operation organization information acquisition unit 106 compares the calculated number of staff members for each department with the number of staff members for each department in another plant for each life stage. The organization information comparison unit 110 outputs a comparison result to the guidance information presentation unit 111. Next, the guidance information presentation unit 111 presents guidance information about the appropriate number of persons according to the life stage and the department (step S65). For example, it is assumed that the number of staff members of the operation department of the other plant of the golden stage is 10 and the number of staff members of the operation department of the current plant (the plant 100) of the golden stage is 20. Then, the guidance information presentation unit 111 outputs guidance information indicating that the “number of staff members in the operation department is large” to the management department terminal device 23.

Staff of the management department can use such guidance information as a trigger for reconsidering the personnel composition of the organization. By reconsidering the organization and redistributing human resources, it is possible to optimize the operation organization.

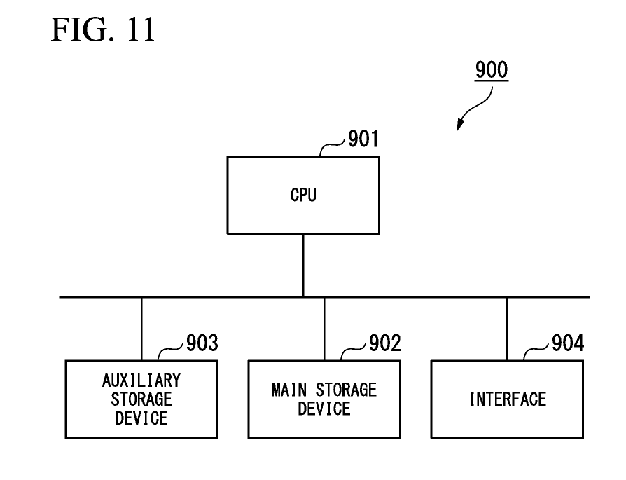

FIG. 11 is a schematic block diagram showing a configuration of a computer according to at least one embodiment.

A computer 900 includes a CPU 901, a main storage device 902, an auxiliary storage device 903, and an interface 904.

The above-described guidance information presentation device 10 includes the computer 900. The operations of the processing units described above are stored in the auxiliary storage device 903 in the form of a program. The CPU 901 reads the program from the auxiliary storage device 903, loads the program to the main storage device 902, and executes the above process in accordance with the program. In accordance with the program, the CPU 901 secures a storage area corresponding to each of the above-described storage units in the main storage device 902.

In at least one embodiment, the auxiliary storage device 903 is an example of a non-transitory tangible medium. Other examples of non-transitory tangible media include a magnetic disk, a magneto-optical disk, an optical disk, a semiconductor memory, and the like connected via the interface 904. When this program is delivered to the computer 900 via a communication circuit, the computer 900 receiving the delivered program may load the program to the main storage device 902 and execute the above process.

Also, the program may be for implementing some of the above-described functions. Furthermore, the program may be a so-called differential file (a differential program) that implements the above-described function in combination with another program already stored in the auxiliary storage device 903.

In addition, it is possible to appropriately replace the components in the embodiment with the well-known components without departing from the scope of the present invention. The technical scope of the present invention is not limited to the above-described embodiment and various modifications can be made without departing from the scope of the present invention.

### INDUSTRIAL APPLICABILITY

According to the above-described guidance information presentation system, guidance information presentation method, program, and guidance information presentation device, it is possible to provide guidance information according to current situations and needs of staff of a plant operation organization.

### REFERENCE SIGNS LIST

1 Guidance information presentation system
10 Guidance information presentation device
20 Maintenance department terminal device
21 Operation department terminal device
22 Technical department terminal device
23 Management department terminal device
100 Plant
100A, 100B Plant device
10 Guidance information presentation device
101 Operation data collection unit
102 Operation time calculation unit
103 Number-of-starts calculation unit
104 Operation mode determination unit
105 Operation state determination unit
106 Operation organization information acquisition unit
107 Calculation unit
108 Lecture attendance information acquisition unit
109 Trouble information acquisition unit
110 Organization information comparison unit
111 Guidance information presentation unit
112 Storage unit

1. A guidance information presentation system comprising:
an operation data collection unit configured to collect operation data of a plant;
an operation mode determination unit configured to determine an operation mode of a plant device provided in the plant on the basis of the collected operation data; and
a guidance information presentation unit configured to present guidance information according to the operation mode.

2. The guidance information presentation system according to claim 1, further comprising an operation time calculation unit configured to calculate an operation time of the plant device on the basis of the collected operation data,
wherein the operation mode determination unit is configured to determine the operation mode of the plant device on the basis of the operation time.

3. The guidance information presentation system according to claim 2, further comprising a number-of-starts calculation unit configured to calculate the number of starts of the plant device on the basis of the collected operation data,
wherein the operation mode determination unit is configured to determine the operation mode of the plant device on the basis of the operation time and the number of starts.

4. The guidance information presentation system according to claim 1, further comprising an operation state determination unit configured to determine an operation state of the plant device on the basis of the operation data,
wherein the guidance information presentation unit is configured to present guidance information according to the operation state and the operation mode.

5. The guidance information presentation system according to claim 1, further comprising an operation organization information acquisition unit configured to acquire information about a department belonging to an operation organization of the plant,
wherein the guidance information presentation unit further is configured to present the guidance information according to the information about the department.

6. The guidance information presentation system according to claim 5, wherein the guidance information presentation unit is configured to present guidance information for prompting staff to attend a lecture of an educational service according to the information about the department and the operation mode.

7. The guidance information presentation system according to claim 5, wherein the guidance information presentation unit is configured to present guidance information for prompting staff to attend a lecture of an educational service required for a generation in accordance with the generation of the staff belonging to the operation organization.

8. The guidance information presentation system according to claim 5, further comprising a lecture attendance information acquisition unit configured to acquire lecture attendance history information about an educational service of a lecture that staff belonging to the operation organization has attended,
wherein the guidance information presentation unit is configured to present guidance information for prompting the staff to receive education on the basis of the lecture attendance history information about the educational service.

9. The guidance information presentation system according to claim 5, further comprising an organization information comparison unit configured to compare information about an operation organization of another plant with information about an operation organization of a current plant,
wherein the guidance information presentation unit is configured to present guidance information for a personnel composition of the operation organization of the current plant on the basis of the comparison.

10. A guidance information presentation method comprising the steps of:
collecting, by a guidance information presentation system, operation data of a plant;
determining, by the guidance information presentation system, an operation mode of a plant device provided in the plant on the basis of the collected operation data; and
presenting, by the guidance information presentation system, guidance information according to the operation mode.

11. A program for causing a computer of a guidance information presentation system to function as:
a means configured to collect operation data of a plant;
a means configured to identify an operation mode of a plant device provided in the plant on the basis of the collected operation data; and
a means configured to present guidance information according to the operation mode.

12. A guidance information presentation device comprising:
a display means configured to display guidance information,
wherein the display means is configured to present the guidance information according to an operation mode of a plant device.
